(19) United States
(12) Patent Application Publication
(10) Pub. No.: US 2006/0274909 A1
(43) Pub. Date: Dec. 7, 2006

(54) Hearing aid with printed circuit board and microphone suspension

(75) Inventor: Bent Severin, Smorum (DK)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: OTICON A/S

(21) Appl. No.: 10/574,102

(22) PCT Filed: Sep. 16, 2004
(86) PCT No.: PCT/DK04/00613

§ 371 Date: Jun. 8, 2006

(30) Foreign Application Priority Data
Oct. 3, 2003 (DK) PA2003 01456

(51) Int. Cl. H04R 25/00

(52) U.S. Cl. 381/330; 381/322

(57) ABSTRACT

A hearing aid for placement behind the ear lobe of a hearing aid user has a rigid circuit board, a microphone and a suspension for holding the microphone, a top shell part with at least one sound inlet opening for directing sound from the environment to the microphone and a bottom shell part which holds the printed circuit board, the microphone suspension including fixing means for attachment thereof to the circuit board.

### AREA OF THE INVENTION

The invention concerns a hearing aid, which is intended for placement behind the ear lobe of a hearing aid user where the hearing aid has a printed circuit board, a microphone and a suspension for holding the microphone, a top shell part with at least one sound inlet opening for directing sound from the environment to the microphone and a bottom shell part which holds the printed circuit board.

### BACKGROUND OF THE INVENTION

In hearing aids of the above kind it is a problem to provide an assembly method which: ensures a sound path from the surroundings to the microphone, provides a safe connection between the microphone and the printed circuit board and allows the top- and bottom shell parts to be parted from each other. In these instruments, the circuit board is held at the bottom part of the two shell parts where the microphone sound input has to be established to the top shell part, while at the same time a reliable and secure electrical connection between the microphone and the circuit board must also be provided. One possible solution could be to fasten the microphone in the top shell part and use long electrical leads between the microphone and the print and thus by way of the long leads allow the bottom and top shell part to be parted from each other. The long leads are however problematic in that they cause increased electrical resistance, picks up electrical noise signals and further it is difficult to have them placed at pre-defined positions at each assembly of the hearing aid. The invention provides a hearing aid of the above kind, where short or no leads at all are required, and where at the same time the hearing aid shell parts are easily parted and assembled without disturbing the electrical or acoustic paths to/from the microphone.

### SUMMARY OF THE INVENTION

By providing a hearing aid as claimed in claim 1 the above problems are solved. By having the microphone associated with the printed circuit board, it is assured that very short leads can be used to provide the electrical connection between the circuit board and the microphone. At the same time the upper shell part and the bottom shell part can be parted and re-assembled in connection with service and maintenance of the hearing aid without violating the leads.

As claimed in claim two, the microphone suspension comprises a sound canal between the microphone and the at least one sound inlet opening in the top shell part. The sound canal thus is made of a rather flexible material, and it will be easy to assure good and sound tight connection with the sound inlet opening in the top shell part of the hearing aid when the top and bottom shell parts are connected.

Further as claimed in claim three it is advantageous to have the fixing means for attachment to the circuit board arranged adjacently to the sound canal. In this way the fixing means are arranged at some distance from the microphone as such, and this helps at the one side to keep the overall size small and at the other side to assure flexible suspension of the microphone.

The fixing means may comprise adhesive or other ways of mechanical attachment means whereby the microphone suspension gains stable contact with the circuit board. Examples hereof could be an aperture in the suspension means may be arranged to embrace a protruding part of the circuit board, or a protruding part of the suspension means which is caused to extend through an aperture in the circuit board.

In a further aspect of the invention according to claim five a method for producing a hearing aid is provided. Accordingly the microphone is connected both through electric wire and by the suspension means to the electric circuit board, and this sub-assembly is then placed in the hearing aid bottom shell, whereupon the top shell is placed over this sub-assembly and fastened to the bottom shell and at the same time the sound inlet opening in the top-shell is tightly connected to the sound canal associated with the microphone suspension. This way of producing the hearing aid is both time saving, and it provides a hearing aid which is easily taken apart and re-assembled for service purposes.

### BRIEF DESCRIPTION OF THE DRAWINGS

FIG. 1 is an exploded side-view of the hearing aid parts according to the invention,

FIG. 2 is an enlarged view of a detail of FIG. 1,

FIG. 3 is a perspective view of the microphone and printed circuit board,

FIG. 4 is a side view of the printed circuit board with the microphone associated therewith.

FIG. 5 is a exploded perspective view of a further embodiment of the invention.

### DESCRIPTION OF A PREFERRED EMBODIMENT

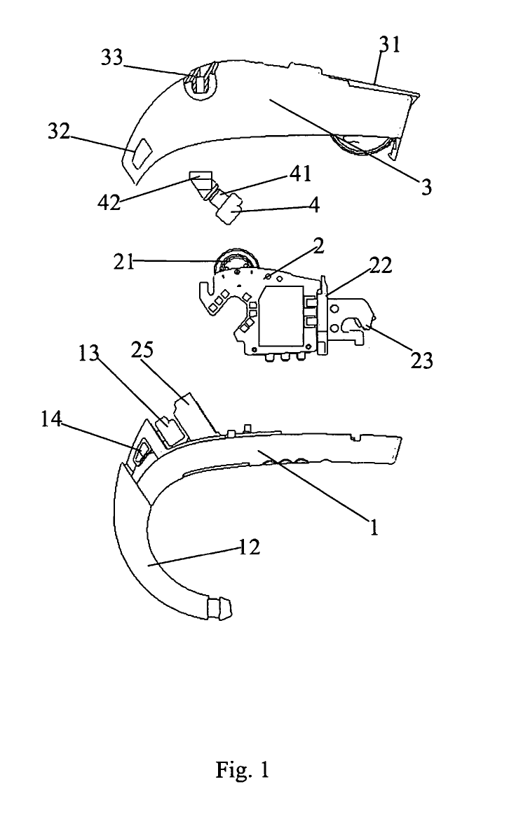

In FIG. 1 a hearing aid according to an embodiment is shown. The hearing aid comprises a bottom shell part 1, a printed circuit board 2, a top shell part 3 and a microphone 4 with suspension 41, 42.

The bottom shell part 1 holds a receiver 25 and a sound outlet 12 and a further microphone 13 with corresponding sound inlet 14.

The printed circuit board 2 is made of a usual rigid PCB, and it holds both a volume wheel 21 and a battery compartment wall 22 with embedded battery connections and a variety of active and passive electronic components as seen in FIG. 3.

The microphone 4 has a microphone casing and a snout part. The snout part is embraced by a suspension part 41 which is integral with the sound canal 42 for directing sound from the surroundings to the microphone casing 40.

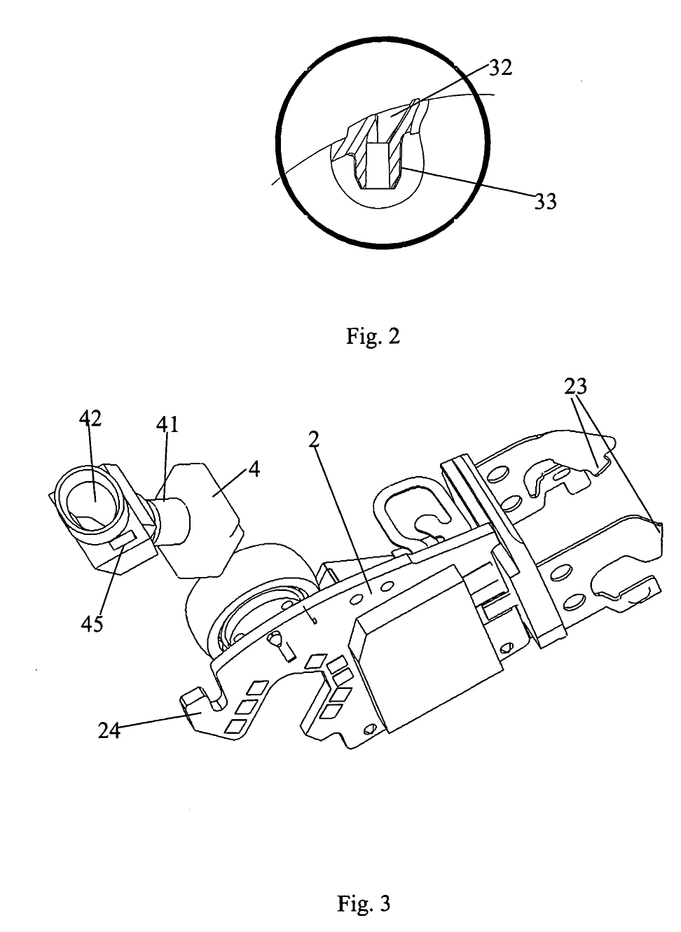

The upper shell part 3 comprises a battery drawer part 31 and has sound inlet openings 32 at both sides for allowing sound to reach the further microphone 13. The sound inlet openings 32 in the tops shell part 3 corresponds with the sound inlets 14 when the top- and bottom shell parts are assembled. Also the top shell part 3 has a further sound inlet opening 33 for guiding sound into the sound canal 42 leading to the microphone 4. As seen in FIG. 2 the sound opening 32 has a snout part 33 which is open towards the inside of the hearing aid. This snout part is dimensioned to receive the mouth of the sound canal 42 when the top shell 3 is placed over the circuit board 2 in order to assemble the top- and bottom parts of the hearing aid.

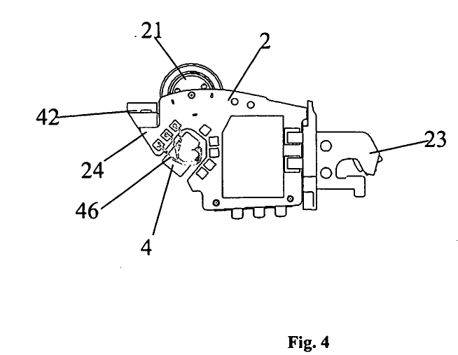

In FIG. 4 the microphone 4 and the circuit board 2 is seen with the microphone 4 in place. The circuit board 2 has a projecting part 24 which is also seen in FIG. 3. The sound canal 42 has a gripping aperture 45 such that this aperture 45 may embrace the projecting part 24 of the circuit board 2 whereby the microphone 4 is suspended at the circuit board 2. In this location it is easy to provide the electric leads 46 between the circuit board 2 and the microphone 4. Once the leads have been provided it is a simple task to assemble the hearing aid. The attachment between the circuit board and the suspension may also be shaped as a protruding part of the suspension which is caused to extend through a hole or aperture in the circuit board (this embodiment is not shown in the drawings).

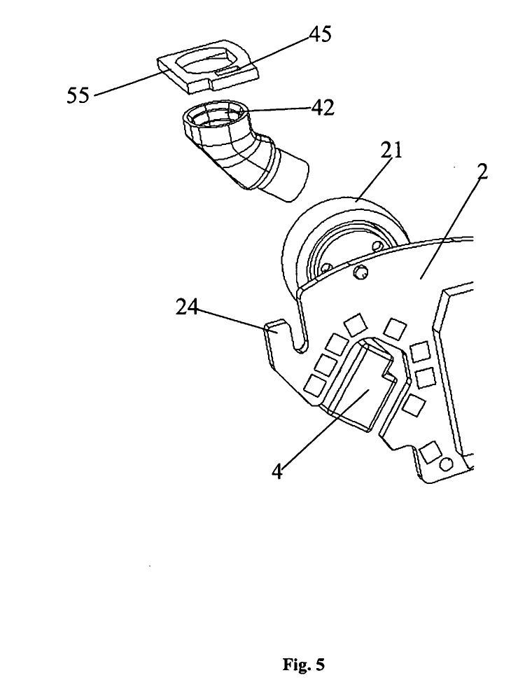

In FIG. 5 a further embodiment of the invention is shown, and here the means for fastening the suspension to the printed circuit board comprises a separate frame part 55 in relation to the canal 42. This makes assembly of the microphone to the circuit board easier. The frame part 55 has the aperture 45, which is to embrace the projecting part 24 of the circuit board 2, while the frame part embraces and holds the canal 42.

1. Hearing aid, which is intended for placement behind the ear lobe of a hearing aid user, where the hearing aid has a rigid circuit board, a microphone and a suspension for holding the microphone, a top shell part with at least one sound inlet opening for directing sound from the environment to the microphone and a bottom shell part which holds the printed circuit board, whereby the microphone suspension comprises fixing means for attachment thereof to the circuit board.

2. Hearing aid as claimed in claim 1, whereby the microphone suspension comprises a sound canal between the microphone and the at least one sound inlet opening in the top shell part.

3. Hearing aid as claimed in claim 2, whereby the fixing means for attachment to the circuit board are arranged adjacently to the sound canal.

4. Hearing aid as claimed in claim 3, whereby the fixing means comprises an aperture, which is arranged to receive a projecting part of the circuit board.

5. Method for producing a hearing aid according to claim 1, whereby firstly the circuit board, the microphone suspension and the microphone is initially assembled and whereby secondly electric wire connections between the microphone and the circuit board are provided and whereupon the subassembly is placed in the bottom shell part and the top shell part is placed over the subassembly such that the sound inlet gains connection with the sound canal of the microphone suspension.
